(19) United States
(12) Patent Application Publication
(10) Pub. No.: US 2007/0282975 A1
(43) Pub. Date: Dec. 6, 2007

(54) Communication device and communication method

(75) Inventor: Hirotsugu Kato, Konosu-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Minato-ku (JP)

(21) Appl. No.: 11/797,448

(22) Filed: May 3, 2007

(30) Foreign Application Priority Data
May 30, 2006 (JP) 2006-150035

(51) Int. Cl. G06F 15/16

(52) U.S. Cl. 709/217; 709/203

(57) ABSTRACT

According to one embodiment, there is provided a communication device including a communication portion which conducts communication with a server device and an external device on a network for controlling contents, a database portion which stores route certificate data, and a processing portion which transmits to the external device address information of the server device and a request for the external device on the network to acquire the content from the server device to process the content, and which, upon receipt of a processing error signal from the external device, conducts an authentication processing of the server device on the basis of the route certificate data via the communication device, acquires the content from the server device, and supplies the obtained content to the external device.

### CROSS-REFERENCE TO RELATED APPLICATION

This application is based upon and claims the benefit of priority from Japanese Patent Application No. 2006-150035, filed May 30, 2006, the entire contents of which are incorporated herein by reference.

### BACKGROUND

1. Field

One embodiment of the invention relates to a communication device between networks, and more particularly to a communication device for acquiring contents from a server device on the internet and processing the contents, and a communication method.

2. Description of the Related Art

In recent years, the network technology has become very prevalent, and there is known a device which conducts an authentication processing and a judgment processing among a plurality of communication devices.

Patent document 1 (Jpn. Pat. Appln. KOKAI Publication No. 2003-196046) discloses a print control device, and a print control method. In the disclosure, change content of the content items which do not match is referred to so that the accepted printing request can be modified using the change content designated by the person who requests the printing in accordance with the reference.

Furthermore, as a non-patent document 1, a network TV terminal specification version 2.0 published on Aug. 1, 2005 (disclosed in http://nw-dtv.jp/documents/index.html) is known.

However, in patent document 1, there is no description of an embodiment in which the host device on the network causes the printing device to acquire all the contents to be printed from the web server or the like, or an embodiment disclosing how to handle errors in server authentication.

Furthermore, no description is made on the aforementioned problems in the non-patent document 1.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic diagram showing one example of a structure of a communication system according to one embodiment of the present invention;

FIG. 2 is a schematic diagram showing another example of the structure of the communication system according to one embodiment of the present invention;

FIG. 3 is a flowchart showing one example of a printing content acquisition processing of the communication system according to one embodiment of the present invention;

FIG. 4 is a flowchart showing one example of a printing content acquisition processing of the communication system according to one embodiment of the present invention;

FIG. 5 is a flowchart showing another example of a printing content acquisition processing of the communication system according to one embodiment of the present invention;

FIG. 6 is a flowchart showing another example of a printing content acquisition processing of the communication system according to one embodiment of the present invention; and

FIG. 7 is a system view showing one example of a LAN which is formed of a communication device according to one embodiment of the present invention.

### DETAILED DESCRIPTION

Various embodiments according to the invention will be described hereinafter with reference to the accompanying drawings. In general, according to one embodiment of the invention, there are provided a communication device and a communication method capable of reliably conducting a processing in the case where a print content is obtained by allowing a host device to operate a printer device to access a server on a network of the print content for which the printer device is designated.

A communication device (P1: host) according to one embodiment of the present invention comprises: a communication portion (15) which conducts communication with a server device (W) and an external device (P2) on a network (L) for controlling contents; a database portion (16) which stores route certificate data; and a processing portion (9) which transmits to the external device address information of the server device (W) and a request for the external device on the network to acquire the content from the server device to process the content, and which, upon receipt of a processing error signal from the external device, conducts an authentication processing of the server device on the basis of the route certificate data via the communication device, acquires the content from the serer device, and supplies the obtained content to the external device.

Thus, in the case where the print content is obtained by allowing the host device to operate the printer device to access a server on the network of the print content for which the printer device is designated, the host device is capable of reliably acquiring the print content even if the server authentication fails at the printer device and the print content cannot be acquired. Hereinafter, embodiments of the present invention will be explained by referring to the drawings.

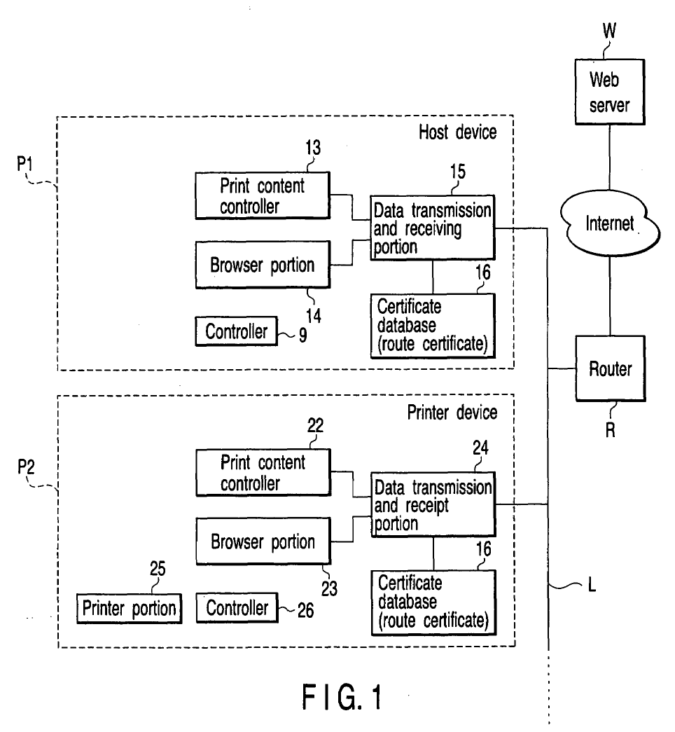

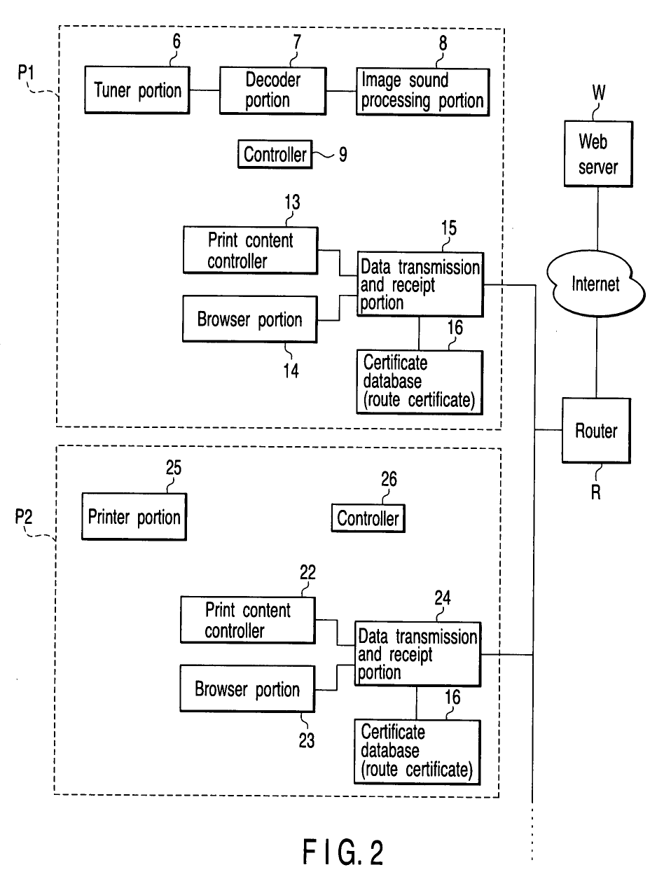

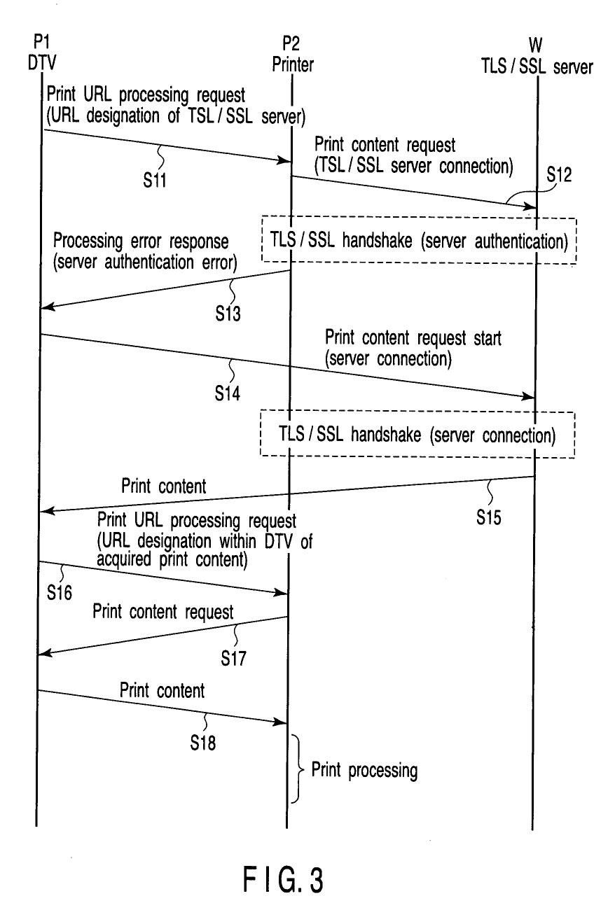

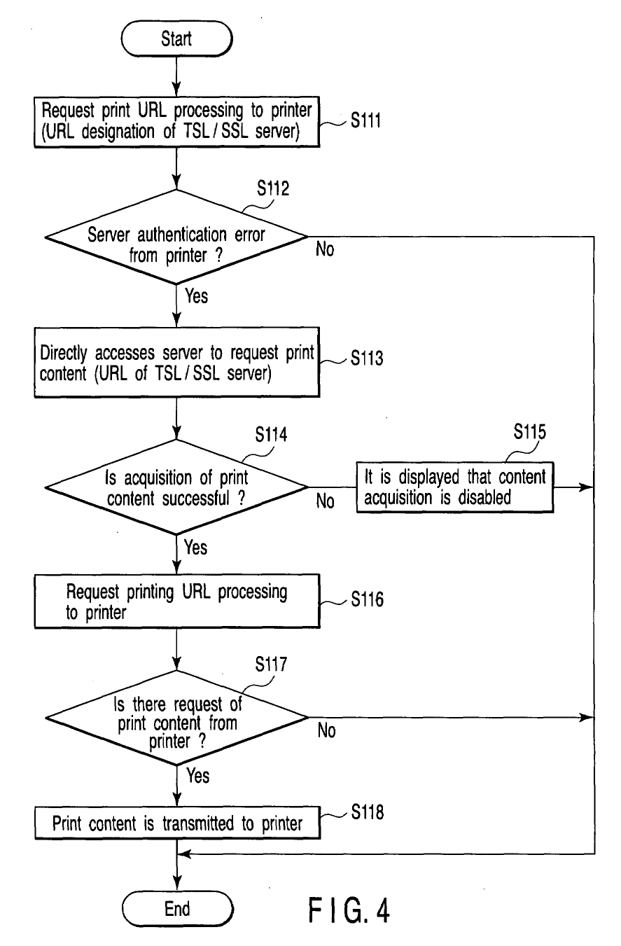

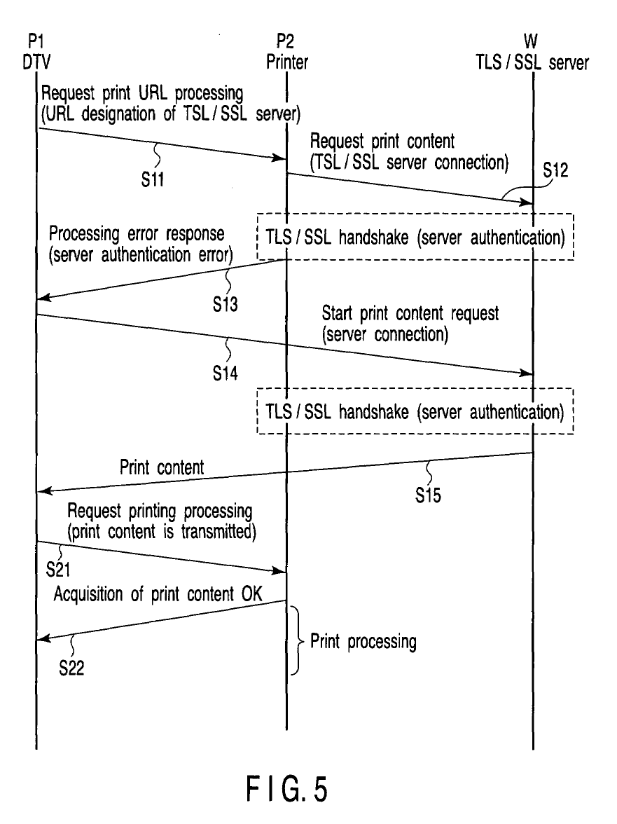

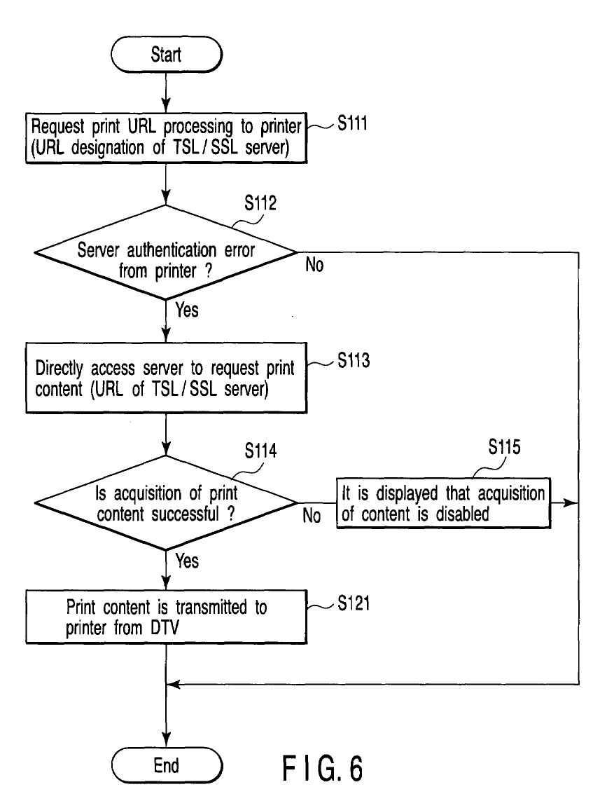

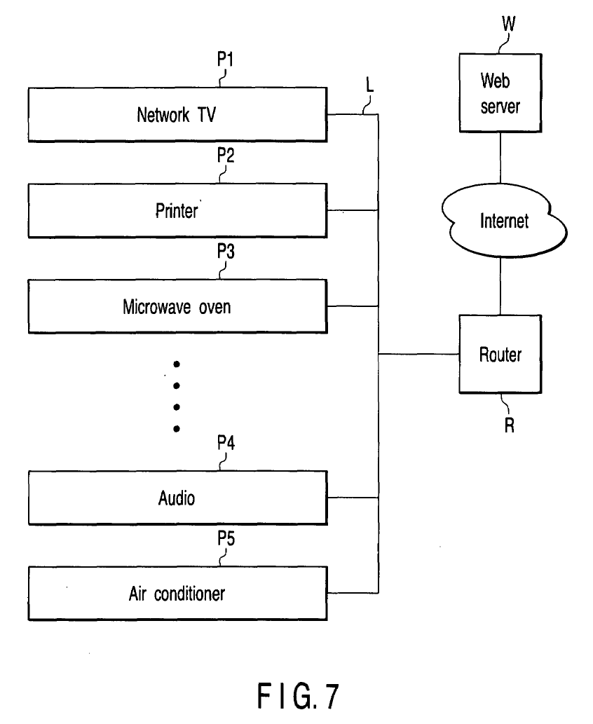

FIG. 1 is a schematic diagram showing one example of a structure of a communication system according to one embodiment of the present invention. FIG. 2 is a schematic diagram showing another example of the structure of the communication system in the same manner. FIG. 3 is a flowchart showing one example of a printing content acquisition processing of the communication system in the same manner. FIG. 4 is a flowchart showing one example of a printing content acquisition processing of the communication system in the same manner. FIG. 5 is a flowchart showing another example of a printing content acquisition processing of the communication system in the same manner. FIG. 6 is a flowchart showing another example of a printing content acquisition processing of the communication system in the same manner. FIG. 7 is a system view showing one example of a LAN which is formed of the communication device in the same manner.

<Host Device and Printer Device>

In a communication device (a host device and a printer device) which is one embodiment of the present invention, as one example, there is processing of print URL designation printing in which the printer accesses the URL of the print content designated by the host device (control point) to acquire the print content. In this process, when the URL of the print content is secure in the server, and the server authentication fails at the printer, the printer notifies the control point that the server authentication has failed, with the result that the host device (control point) conducts again an acquisition processing on the secure URL of the same print content. Then, when the acquisition of the print content is successful, the URL of the print content inside the control point is designated to the printer to request a processing of print URL designation printing, with the result that the printer accesses the URL of the designated print content and acquires the print content for conducting the print processing.

As a consequence, in the case where the certificate for the server authentication of the printer does not agree with the control point, it is possible to acquire the print content at the control point even when the server authentication cannot be conducted with the printer. Therefore, the print processing of the print content can be reliably conducted.

(Constitution)

A communication device (a host device and a printer device) according to one embodiment of the present invention is connected with a network circuit L of, for example, a LAN (local area network) as shown in FIGS. 1 and 2.

Here, a host device P1 has, as shown in FIGS. 1 and 2, a controller 9 for controlling an entire operation, a print content controller 13 for conducting a processing of the print content, a browser portion 14, a data transmission and receipt portion 15, and a certificate database 16 which has stored in advance a plurality of route certificates. Furthermore, the host device P1 is, for example, a network television device. The host device P1 has a tuner portion 6, a decoder 7, and an image sound processing portion 8 as shown in FIG. 2.

On the other hand, a printer device P2 (preferably various application devices as will be described in FIG. 7 without being limited to the printer device) has a controller 26 for controlling an entire operation, a print content controller 22 for conducting a processing of a print content, a browser 23, a data transmission and receipt portion 24, a printer portion 25, and a certificate database 16 which has stored in advance a plurality of route certificates. Here, the certificate database 16 is not necessarily provided.

In addition, a router R is connected to the network circuit L to enable communication with a web server device W on the internet.

<Processing of Acquiring Print Content According to One Embodiment of the Present Invention>

Next, one example of a processing of acquiring a print content between the host device and the printer device according to one embodiment of the present invention will be explained in detail hereinbelow on the basis of the flowcharts shown in FIGS. 3 to 6. Here, one example of the host device P1 will be explained by using a digital television set.

Explanation in accordance with Data Flowchart (FIG. 3)

Between the host device and the printer device according to one embodiment of the present invention, as shown in the flowchart shown in FIG. 3, the print URL processing request signal is first transmitted along with address information of the server device (W), from the digital television set P1 to the printer P2, by means of operations of the controller 9 and the print content controller 13 in FIG. 1 (step S11). The print URL processing request signal is a request signal for allowing the printer P2 or the like to acquire the content from the server device to process the content.

Next, in response to the print URL processing request signal, the printer P2 accesses a web server on the network by the operation of the controller 26, and the print content controller 22 and the data transmission and receipt portion 24, to conduct a TSL/SSL server connection (step S12).

As a consequence, the printer device P2 conducts a TSL/SSL handshake processing to receive a server certificate from the web server device W, and conducts the server authentication with the route certificate by means of the certificate database itself.

However, in the case where the printer device P2 fails in the server authentication because the printer device P2 does not store an appropriate route certificate, the printer device P2 notifies the host device P1 (control point) of the failure in the server authentication by a server authentication error signal or the like (step S13).

With respect to this server authentication error signal, the digital television set P1 directly accesses the web server W on the network via the data transmission and receipt portion 15 this time by means of the operations of the controller 9 and the print content controller 13, thereby requesting the print content (step S14). Here, the digital television set P1 checks the server certificate from the web server W with the route certificate on the certificate database 16 itself to confirm the validity of the web server W, by means of the operations of the controller 9 and the print content controller 13 (TLS/SSL handshake processing). As a result, the digital television set P1 acquires the print content after confirming the validity of the web server W (step S15).

Then, the digital television set P1, upon acquiring the print content, transmits the print URL processing request signal to the printer P2 again by means of the operations of the controller 9 and the print content controller 13 (step S16). The printer P2, upon receipt of this printing URL processing request signal, transmits the print content request signal to the digital television set P1 (step S17). In accordance with this, the digital television set P1 supplies the acquired print content to the printer P2 (step S18). As a result, the printer P2 forms an image of this print content on the recording medium in accordance with the content image information.

As a consequence, the digital television set P1 and the printer device P2 according to one embodiment of the present invention are capable of acquiring the print content at the control point (digital television set P1) even if the server authentication cannot be conducted with the printer in such a case in which the control point does not agree with the certificate for the server authentication. Thus, the printing of the print content can be conducted reliably.

Explanation by Means of Flowchart (FIG. 4)

Next, by noting a processing of an access pointer such as the digital television set P1 (control point), there will be explained the aforementioned operation in detail using the flowchart of FIG. 4.

That is, in the beginning, the digital television set P1 (a control point) conducts the print URL processing request to the printer P2 (step S111). Next, in the printer P2, when an error is caused in the server authentication, a server authentication error signal is supplied to the digital television set P1 (step S112).

In this case, the digital television set P1 directly accesses the server device W to request the print content. At this time, the TSL/SSL handshake processing is conducted (step S113).

When the digital television set P1 fails in the acquisition of the print content (step S114), it is preferable to provide a display of “content acquisition disabled” on the screen or the like of the digital television set P1, for example, with the controller 9 and the print content controller 13 (step 115).

Furthermore, at step S114, in the case where the digital television set P1 has succeeded in the acquisition of the print content, the digital television set P1 supplies again the print URL processing request signal or the like to the printer P2 this time (step S116). Here, when a request signal of the print content is given from the printer P2 (step S117), the print content acquired from the digital television set P1 is transmitted to the printer P2 in response to the signal. As a consequence, the printer P2 forms an image onto the recording medium in accordance with the image information of the content by the printer portion 25.

(Processing of Acquiring Print Content According to Other Embodiment of the Present Invention; FIGS. 5 and 6)

Incidentally, like the case shown in FIGS. 3 and 4 which has been described above, it is also preferable that the print URL processing request signal and the print content are transmitted at the same time without waiting for the print content request signal from the printer P2, by supplying again the print URL processing request signal to the printer P2 in the case where the digital television set P1 has succeeded in the acquisition of the print content.

That is, at step S21 in FIG. 5, the print URL processing request signal and the print content are simultaneously transmitted from the digital television set P1 to the printer P2. In response to this, the printer P2 returns an OK signal of the acquisition of the print content while starting the printing of the content. As a consequence, the number of signals transmitted and received between the digital television set P1 and the printer P2 can be decreased, with the result that the content printing processing can be reliably conducted.

(Structure of Other Network)

In FIG. 7, an example of a communication device having various functions is shown. Here, not only the network television P1 on the network L and the printer device P2, but also home electric appliances such as a microwave oven P3, an audio device P4, and an air conditioner P5 are preferable in the same meaning. That is, in the recent network device, it becomes useful to acquire various forms of contents from the web server W or the like of the outside network such as the internet. For example, with respect to the microwave oven, it is useful to download specific recipe information and use them. Furthermore, with respect to the audio device P4, it becomes useful to download music contents and use them. For example, with respect to the home electric appliances such as an air conditioning device including the air conditioner P5, it becomes possible to download a program for improving an operation failure or the like.

Consequently, as in the communication system according to the present invention, it is extremely significant to access the internet in a self-sustaining manner with ease to download required data even if the route certificate data is not available, only by receiving an instruction command from a device which has a host function of a personal computer, a television set or the like.

Incidentally, in the aforementioned embodiment, a communication protocol is explained by using the HTTP. In the embodiment of the present invention, the same operation and effect can be provided in the same processing by using other communication protocol in addition to this communication protocol.

With various embodiments described above, those skilled in the art can realize the present invention. Furthermore, it is easy for those skilled in the art to think of various variations of the embodiments. It is easy to apply the invention to various embodiments without the capacity of the inventions. Consequently, the present invention extends over a wide scope which does not contradict the disclosed principle and new characteristics. The invention is not limited to the aforementioned embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication device comprising:
a communication portion which conducts communication with a server device and an external device on a network for controlling contents;
a database portion which stores route certificate data; and
a processing portion which transmits to the external device address information of the server device and a request for the external device on the network to acquire the content from the server device to process the content, and which, upon receipt of a processing error signal from the external device, conducts an authentication processing of the server device on the basis of the route certificate data via the communication device, acquires the content from the serer device, and supplies the obtained content to the external device.

2. The communication device according to claim 1, wherein the processing portion supplies to the external device an image formation command onto a recording medium corresponding to image information of the content.

3. The communication device according to claim 1, wherein the processing portion transmits a print request signal to the external device after acquiring the content from the server device via the communication portion and sends the content upon receipt of a request for sending the content from the external device.

4. The communication device according to claim 1, wherein the processing portion transmits the printing request signal and the content to the external device after acquiring the content from the server device via the communication portion.

5. A communication device comprising:
a communication portion which conducts communication with a server device and the communication device on a network for controlling contents; and
a processing portion which accesses the server device on the internet shown by address information via the communication portion upon receipt of the address information of the server device for controlling the content and a processing command of the content from the communication device on the network via the communication portion, which receives server certificate data from the server device, which receives the content from the server device to process the content when the server certificate data is determined to be valid, and which transmits an error signal to the communication device when the server certificate data cannot be determined to be valid.

6. The communication device according to claim 5, wherein the processing portion receives from the external device an image formation command onto a recording medium corresponding to image information of the content, and forms an image onto the recording medium corresponding to the image information of the content.

7. The communication device according to claim 5, wherein the processing portion transmits a request signal in order to request the content to the communication device when a print request is made from the communication device after the transmission of the error signal to the communication device, and then forms an image on a recording medium in accordance with image information of the content when the content is acquired from the communication device.

8. The device according to claim 5, wherein the processing portion forms an image on a recording medium in accordance with image information of the content upon acquiring the print request and the content from the communication device after the transmission of the error signal to the communication device.

9. A communication method used between a first communication device and a second communication device provided on a network, the method comprising:
supplying to the second communication device on the network address information of a server device for controlling contents and a processing command of the content in the first communication device;
upon receipt of the address information of the server device and the processing command of the content from the first communication device, accessing the server device on the internet shown by the address information, receiving server certificate data from the server device to judge whether or not the server certificate data is valid, and transmitting an error signal to the first communication device in the case where the server certificate data is not determined to be valid, in the second communication device;
accessing the server device upon receipt of the error signal, receiving the server certificate data from the server device, and acquiring the content in the case where the server certificate data is determined to be valid, thereby supplying to the second communication device the content together with the processing command of the content, in the first communication device; and
conducting the processing on the basis of the acquired content upon receipt of the content and the processing command of the content from the first communication device, in the second communication device.

10. The communication method according to claim 9, wherein upon receipt of the content and the processing command of the content from the first communication device, the second communication device forms an image, on a recording medium, according to image information of the acquired content.

11. The communication method according to claim 9, wherein the first communication device transmits a print request signal to the second communication device after acquiring the content from the server device, and transmits the content when the transmission of the content is requested by the second communication device.

12. The communication method according to claim 9, wherein the first communication device transmits a print request signal and the content to the second communication device after acquiring the content from the server device.
